(19) United States
(12) Patent Application Publication
(10) Pub. No.: US 2005/0231474 A1
(43) Pub. Date: Oct. 20, 2005

(54) Electrical device capable of auto-adjusting display direction according to a tilt of a display

(76) Inventors: Ching-Jun Su, Taipei Hsien (TW); Tung-Sheng Lin, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 10/710,440

(22) Filed: Jul. 12, 2004

(30) Foreign Application Priority Data
Apr. 20, 2004 (TW) 093110971

(51) Int. Cl. G09G 3/36; G09G 5/08

(52) U.S. Cl. 345/158

(57) ABSTRACT

An electrical device capable of auto-adjusting display direction according to a tilt of a display is provided. The electrical device includes a housing, a display panel installed on the housing, a gravity sensor for outputting a sensing parameter based on a tilt angle of the display panel, a direction control device for generating direction signals, and a micro-controller for adjusting the display direction of the display panel based on the sensing parameter and for adjusting the indicated direction corresponding to direction signals generated by the direction control device.

### BACKGROUND OF INVENTION

1. Field of the Invention

The present invention relates to an electrical device, and more specifically, to an electrical device capable of auto-adjusting the displayed image direction based on the rotation of the display panel.

2. Description of the Prior Art

In the modern information era, personal computers (PCs) have become essential individual tools. Conventional desktop PCs, due to their larger volume and heavy weight, are not suitable to be carried around. Conversely, the hand-held electrical devices with smaller volume and light weight, such as notebook PCs, personal digital assistants (PDAs) and tablet PCs, are more popular to users for looking up, viewing, or storing an amount of data.

Please refer to FIG. 1, which shows a conventional portable computer 10. The portable computer 10 comprises a housing 11, a touch panel 12 and a direction control device 14. The portable computer 10 usually uses a user interactive touch display panel functioning as an interface between a user and the portable computer 10 to display digital data on a large-area screen. The display panel 12 functions as a touch panel for sensing a position of pressure exerted by a user for controlling the portable computer 10 according to different pressure positions within the touch panel. Furthermore, due to advancement of handwriting identification technology, the user can directly press the display panel 12 or use a touch pen 18 to write down information when the user wishes to input the information to the portable computer 10. Therefore, the portable computer 10 can identify the information inputted by the user according to write-traces of the user detected by the display panel 12 so as to input the information to the portable computer. The handwriting input can not only reduce space occupied by the portable computer 10, but also supply a better interface so that the user can control the portable computer 10 via the display panel 12. In addition, the user can control the direction of the displayed image on the display panel 12 by means of the direction control device 14.

Please refer to FIG. 2, which shows a graph of the portable computer 10 depicted in FIG. 1 rotating 90 degrees. The display panel 12 just displays narrow width images. For example, as shown in FIG. 1, for an image 15 having a broad width (that the image 15 shows the word “CAT”), the portable computer 10 fails to display the image 15 completely. Therefore, the user can manipulate the direction control device 14 to move the image 15, so that the non-displayed part of the image 15 can be displayed. Meanwhile, on account of the fixed size of the display panel 12, part of original visible image 15 will be hidden. If the user rotates the portable computer 10 by 90 degrees from the status of FIG. 1 to that of FIG. 2, the display panel 12 can show broader width. Nevertheless, the user must adjust the displayed direction manually, which is very inconvenient for user.

### SUMMARY OF INVENTION

It is therefore an objective of the claimed invention to provide an electrical device capable of auto-adjusting the displayed image direction based on the rotation of the display panel, in order to solve the above-mentioned problems.

According to the claimed invention, an electrical device capable of auto-adjusting display direction according to a tilt of a display comprises a housing, a display panel installed on the housing, a gravity sensor for outputting a sensing parameter based on a tilt angle of the display panel, a direction control device for generating direction signals, and a micro-controller for adjusting the display direction of the display panel based on the sensing parameter and for adjusting the indicated direction corresponding to direction signals generated by the direction control device.

These and other objectives of the claimed invention will no doubt become obvious to those of ordinary skill in the art after reading the following detailed description of the embodiment, which is illustrated in the various figures and drawings.

### BRIEF DESCRIPTION OF DRAWINGS

FIG. 1 shows a conventional portable computer.

FIG. 2 shows a graph of the portable computer depicted in FIG. 1 rotating 90 degrees.

FIG. 3 shows a portable computer positioned on a surface according to the present invention.

FIG. 4 is a block diagram of the portable computer depicted in FIG. 3.

FIG. 5 is a block diagram of the G sensor depicted in FIG. 4.

FIG. 6 is a timing diagram of output voltage of the G sensor.

FIGS. 7-10 show a schematic diagram of the portable computer depicted in FIG. 3 at various situations corresponding to tilt angles sensed by the G sensor.

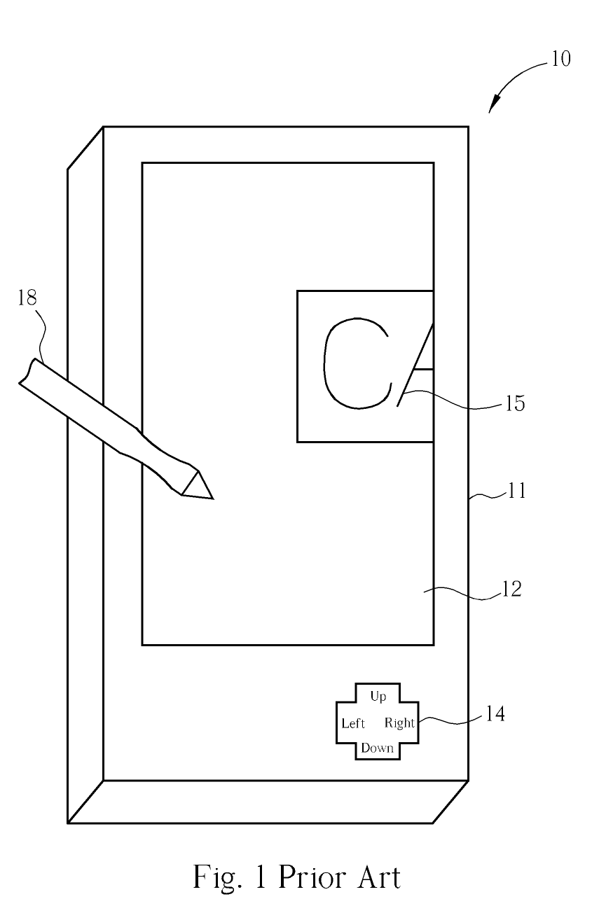

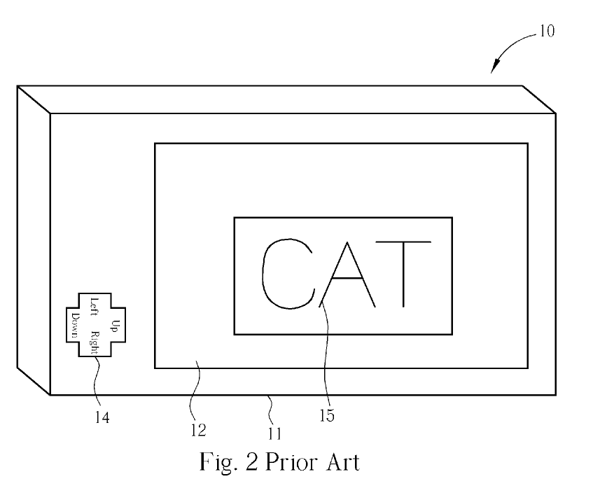

### DETAILED DESCRIPTION

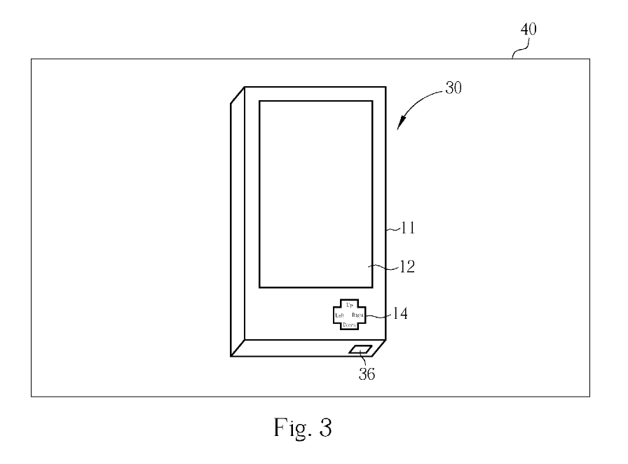

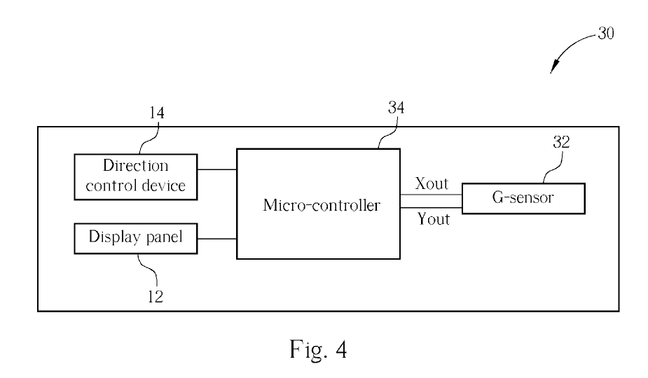

Please refer to FIG. 3 and FIG. 4. FIG. 3 shows a portable computer 30 positioned on a surface 40 according to the present invention. FIG. 4 is a block diagram of the portable computer 30 depicted in FIG. 3. The portable computer 30 comprises a housing 11, a display panel 12 installed on the housing 11, a direction control device 14 for generating direction signals, a micro-controller 34, and a gravity sensor (G sensor) 32 installed within the housing 11. The direction control device 14 is a set of four-direction buttons installed on the housing 11, a joystick or a track ball connected to the connection port 36 on the housing 11.

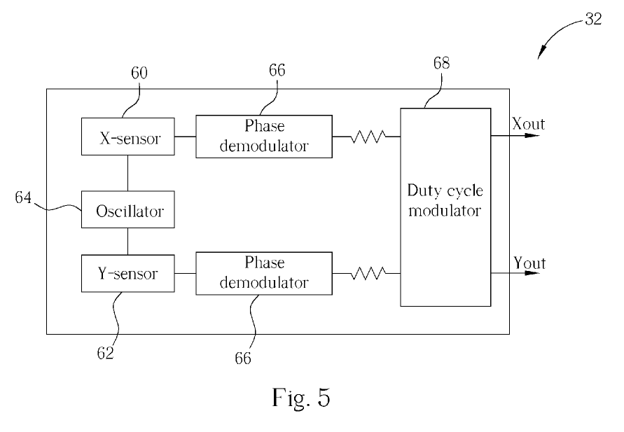

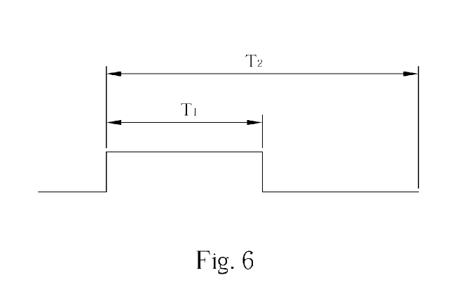

Please refer to FIG. 5 and FIG. 6. FIG. 5 is a block diagram of the G sensor 32 depicted in FIG. 4. FIG. 6 is a timing diagram of output voltage of the G sensor 32. The G sensor 32 comprises an X-sensor 60, a Y-sensor 62, an oscillator 64, two phase demodulators 66, and a duty cycle modulator 68. The oscillator 64 is used for generating signals having 90 degrees phase difference. The X-sensor 60 and the Y-sensor 62 are respectively used for sensing the tilt with respect to the x-coordinate and the y-coordinate and outputting various amplitude square waves based on the tilt angle. The phase demodulators 66 respectively coupled to the X-sensor 60 and the Y-sensor 62 are used for rectifying the square wave. The duty cycle modulator 68 transforms the rectified signal into a square wave with different duty cycles, as shown in FIG. 6. The square wave with 50% duty cycle (i.e. T1/T2=0.5 shown in FIG. 6) indicates that the tilt angle φₓ sensed by the x-sensor 60 is 0 degrees, or the tilt angle φ_{y} sensed by the Y-sensor 62 is 90 degrees. When either the X-sensor 60 or the Y-sensor 62 senses the tilt angle, the duty cycle modulator 68 will output the voltage with various duty cycles at either of the output ends Xₒᵤₜ or Yₒᵤₜ.

When the G sensor 32 as well as the display panel 12 is tilted, it can output voltages with different duty cycles based on different tilt angles. Therefore, the microcontroller 34 can determine the tilt angle of the display panel 12 based on the different output voltages.

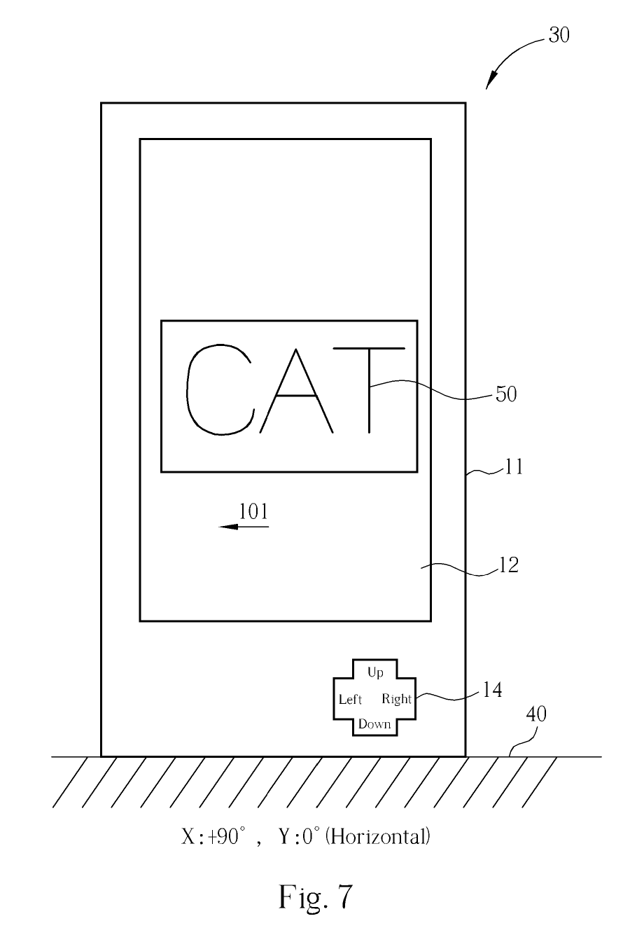

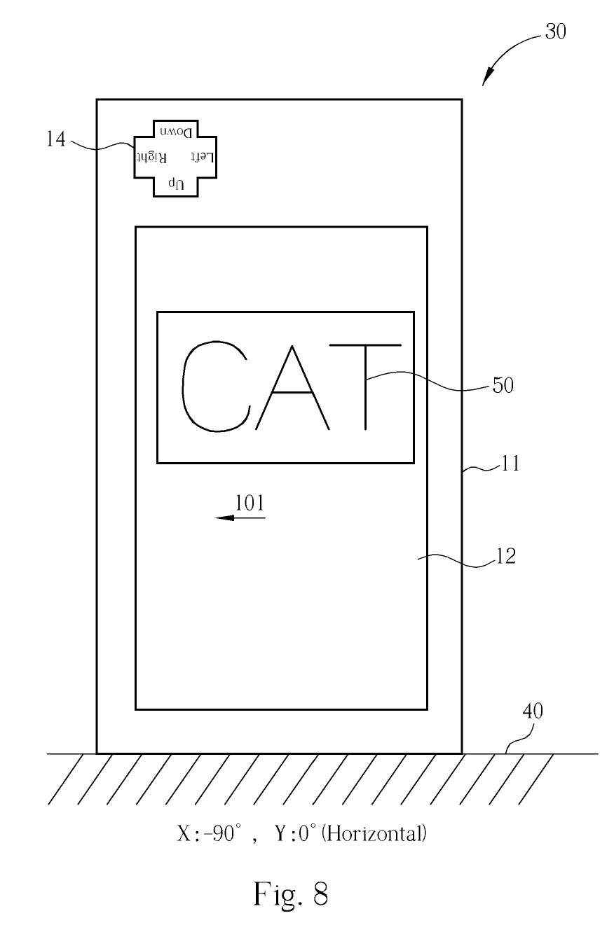

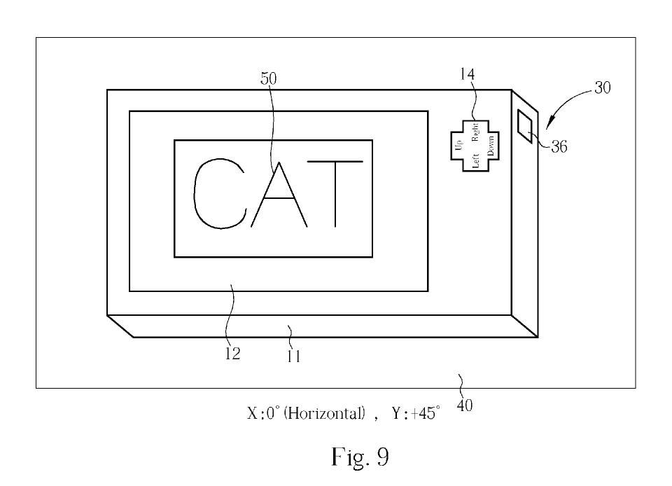

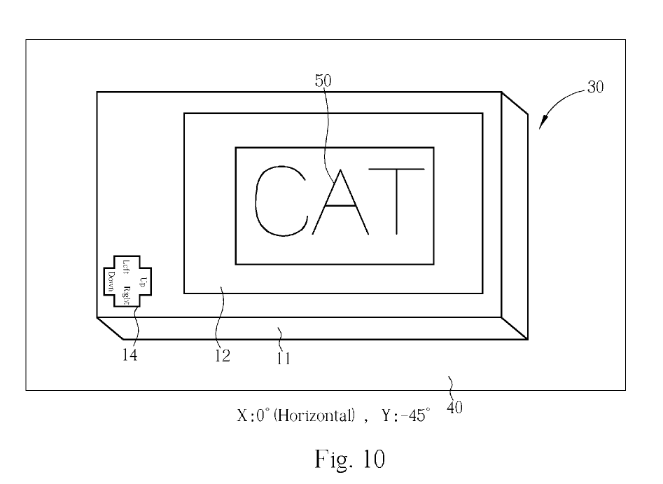

Please refer to FIGS. 7-10, which show a schematic diagram of the portable computer 30 depicted in FIG. 3 at various situations corresponding to tilt angles sensed by the G sensor 32. Suppose that the portable computer 30 is positioned on a surface 40 as shown in FIG. 7 as the X-sensor 60 of the G sensor 32 senses the tilt angle φₓ is +90 degrees and the Y-sensor 62 senses the tilt angle φ_{y} is 0 degrees, i.e. horizontal. At this moment, the display panel 12 shows image (characters “CAT”) 50 under the first mode. If the portable computer 30 is rotated, as can be seen from FIG. 8, the X-sensor 60 senses that the tilt angle φₓ is 90 degrees and the Y-sensor 62 senses that the tilt angle φ_{y} is 0 degrees, i.e. horizontal. At this moment, the G sensor 32, due to a change of the tilt angle φₓ, will generate and output different duty cycle output voltages based on different tilt angle. The micro-controller 34 can determine the tilt angle of the display panel 12 based on the duty cycle of the output voltage and adjust the displayed direction of the display panel 12 and the direction signal generated by the direction control device 14 for controlling the moving direction of the displayed image on the display panel 12. For example, as shown in FIG. 7, when triggering a “Left” button on the portable computer 30, a direction signal used for controlling the image to move toward the direction of arrow 101 is generated. When triggering a “Right” button, a direction signal used for controlling the image to move toward the reverse direction of arrow 101 is generated. If the portable computer 30 is rotated, as shown in FIG. 8, triggering the “Left” button generates a direction signal used for controlling the image to move toward the reverse direction of arrow 101. Conversely, triggering the “Right” button generates a direction signal used for controlling the image to move toward the direction of arrow 101. Similarly, as shown in FIG. 9, the X-sensor 60 senses the tilt angle φₓ is 0 degrees i.e. horizontal, and the Y-sensor 62 senses the tilt angle φ_{y} is +45 degrees. In FIG. 10, the X-sensor 60 senses the tilt angle φₓ is 0 degrees i.e. horizontal, and the Y-sensor 62 senses the tilt angle φ_{y} is −45 degrees. Therefore, the micro-controller 34 can detect the different tilt angles φₓ and φ_{y} to determine the tilt of the display panel 12, thereby adjusting the displayed image direction of the display panel 12 and the direction signals generated by the direction control device 14.

Briefly speaking, four control modes are defined by this embodiment portable computer 30, each corresponding to a display direction of the display panel 12 and for moving the direction of the direction signals generated by the direction control device 14. For example, suppose that when the portable computer 30 is placed as shown in FIG. 7, and the tilt angle φₓ transition is between 0 degrees and +90 degrees, the display panel 12 displays the image and the direction control device 14 is operated at a first control mode, as shown in FIG. 7. When the tilt angle φₓ transition is between 0 and 90 degrees, the microcontroller 34 change the portable computer 30 to the second control mode, in which the displayed image of the display panel 12 and the direction signals generated by the direction control device 14 are all the reverse of those under the first mode. Similarly, if the tilt angle φ_{y} is between +90 degrees and 0 degrees, as shown in FIG. 9, the display panel 12 and the direction control device 14 are operated under the third control mode set by the microcontroller 34. If the tilt angle φ_{y} transition is between 0 and 90 degrees, the micro-controller 34 can adjust the display panel 12 and the direction control device 14 operated under the fourth mode, in which the displayed image of the display panel 12 and the direction signals generated by the direction control device 14 are all the reverse of those under the third mode.

Please notice that, how large the tilt angles of φₓ or φ_{y} is required to switch the control modes can determined by the designer.

The portable computer 30 can be a personal digital assistant (PDA), a tablet PC, a digital camera, or a digital camcorder.

In contrast to prior art, the G sensor of the present invention portable computer can output a detecting voltage based on a tilt of the display panel. Based on the detecting voltage, the micro-controller can adjust the display direction of the display panel and the direction signals which are used for controlling the movement of displayed image. In doing so, the user can adjust the tilt of the display panel at random, and does not have to worry about inconsistently displayed images shown on the display panel.

Those skilled in the art will readily observe that numerous modifications and alterations of the device may be made while retaining the teachings of the invention. Accordingly, the above disclosure should be construed as limited only by the metes and bounds of the appended claims.

1. An electrical device capable of auto-adjusting display direction according to a tilt of a display comprising:
a housing;
a display panel installed on the housing for displaying images;
a gravity sensor for generating a sensing parameter based on a tilt of the display panel;
a direction control device for generating direction signals; and
a micro-controller for adjusting the display direction of the display panel based on the sensing parameter, and for adjusting the indicated direction corresponding to direction signals generated by the direction control device.

2. The electrical device of claim 1, wherein the direction control device is a set of four-direction buttons.

3. The electrical device of claim 1, wherein the direction control device is set on the housing.

4. The electrical device of claim 1, wherein the direction control device is a joystick or a track ball connected to the housing of the electrical device.

5. The electrical device of claim lbeing capable of displaying the images in four different directions.

6. The electrical device of claim 5, wherein the microcontroller switches the display direction of the display panel when the tilt angle detected by the G sensor reaches a predetermined angle.

7. The electrical device of claim 1 being a personal digital assistant, a tablet PC, a digital camera or a digital camcorder.
